(19) United States
(12) Patent Application Publication
(10) Pub. No.: US 2008/0271514 A1
(43) Pub. Date: Nov. 6, 2008

(54) System and Method for Precise Liquid Measurement in a Liquid Sampling Pipette

(75) Inventors: Francois Viot, Auvers-sur-Oise (FR); Yves May, Versailles (FR)

Correspondence Address: FOLEY & LARDNER LLP, 150 EAST GILMAN STREET, P.O. BOX 1497, MADISON, WI, 53701-1497, US

(73) Assignee: GILSON S.A.S., Villiers-le-Bel (FR)

(21) Appl. No.: 10/580,725

(22) PCT Filed: Nov. 24, 2004
(86) PCT No.: PCT/IB04/03876

§ 371 Date: May 9, 2007

(30) Foreign Application Priority Data
Nov. 27, 2003 (FR) 0313920
Nov. 27, 2003 (FR) 0313921
Mar. 9, 2004 (FR) 0402433
Sep. 7, 2004 (FR) 0409438
Sep. 7, 2004 (FR) 0409442
Sep. 7, 2004 (FR) 0409443
Sep. 17, 2004 (US) 10/944532

(51) Int. Cl. G12B 13/00; B01L 3/02

(52) U.S. Cl. 73/1.01; 73/864.14

(57) ABSTRACT

A device and method are provided for correcting a requested volume of liquid to aspirate/dispense by a liquid-handling pipette based on the requested volume and/or a physical condition at the pipene. The pipette includes a piston drive mechanism configured to contact a piston assembly and move a piston rod of the piston assembly within a tip holder thereby causing regulation of an amount of liquid in the tip holder. The method includes selecting a requested volume at a pipette, the requested volume representing the amount of liquid to regulate, calculating a correction volume using a volume characterization, wherein the volume characterization characterizes a difference in the amount of the liquid regulated in the tip holder as a function of the requested volume, and displaying the correction volume to a user of the pipette thereby regulating the requested volume of liquid in the tip holder. The volume characterization is determined using a calibration process.

### FIELD OF THE INVENTION

The present invention is related generally to a pipette for aspirating and for dispensing adjustable volumes of liquid. More specifically, the present invention relates to a liquid sampling pipette for measuring precise volumes of liquid.

### BACKGROUND OF THE INVENTION

In pharmaceutical, genomic, and proteomic research, biology research, drug development laboratories, and other biotechnology applications, a liquid pipette is used to handle laboratory samples in a variety of laboratory procedures. Using a pipette, a volume of liquid is aspirated into the pipette. The volume of liquid may then be dispensed in one or more dispensation volume. A piston drive mechanism controls the aspiration and the dispensation of the liquid in specified volumes by imparting motion to a piston assembly. A pipette may operate in a manual mode wherein the user manually controls the speed and the volume of aspiration or of dispensation of the liquid using a pressure sensitive knob. Alternatively, a pipette may operate in an motorized mode wherein a motor controls the aspiration and/or dispensation of the liquid. In either mode, the pipette may have electronic components that, for example, display a requested volume to aspirate. The user may select various parameters including a speed, a volume, a number of aspirations, a number of dispensations, etc. using a display mounted to the pipette. Motion of the piston rod is controlled by a thrust exerted by the piston drive mechanism. In a motorized pipette, the motion of the piston rod is typically controlled by a small processor placed within the housing of the pipette.

In either motorized or non-motorized pipettes, errors in the amount of liquid actually regulated by the pipette occur based on a variety of effects. One observed effect occurs when a small volume is requested for sampling. The actual volume sampled is greater than the requested volume. For small sampled volumes, the error is due to capillarity phenomena. Conversely, for large requested volumes of liquid, the actual volume sampled is lower than requested. For large sampled volumes, the error is due to the weight of the liquid column that compresses the liquid. Additional, errors occur based on a current operational temperature of the pipette as compared to a calibration temperature of the pipette. For example, heating of the pipette occurs after prolonged handling by the user. Heating of the pipette causes expansion of the components that regulate the amount of liquid aspirated or dispensed, thus causing errors in the aspiration of the requested volume. In a cold pipette, the components contract. Still additional errors occur based on the current atmospheric conditions at the pipette that differ from calibration atmospheric conditions. For example, a temperature, a pressure, and/or a humidity of the atmosphere in which the pipette is operated may differ from atmospheric parameters associated with the calibration of the pipette. What is needed, therefore, is a method of correcting for a current physical condition of the pipette and/or for a current requested volume thereby providing for the precise regulation of a requested volume of liquid in a liquid handling pipette. What is further needed is a method for improving the precision of the pipette while reducing the sales price of the pipette and simplifying its manufacture.

### SUMMARY OF THE INVENTION

An exemplary embodiment of the invention relates to a method of regulating a requested volume of liquid in a liquid handling pipette by correcting for a current physical condition of the pipette. The method includes, but is not limited to, selecting a requested volume at a pipette, the pipette including a piston drive mechanism, the piston drive mechanism configured to contact a piston assembly to move a piston rod of the piston assembly within a tip holder thereby causing regulation of an amount of liquid in the tip holder, the requested volume representing the amount of liquid to regulate; calculating a correction volume using a volume characterization, wherein the volume characterization characterizes a difference in the amount of the liquid regulated in the tip holder as a function of the requested volume, the volume characterization determined using a calibration process; and displaying the correction volume to a user of the pipette thereby regulating the requested volume of liquid in the tip holder.

Another exemplary embodiment of the invention relates to a device for regulating a requested volume of liquid in a liquid handling pipette by correcting for a current physical condition of the pipette. The device includes, but is not limited to, a body, a tip holder, a piston assembly, a piston drive mechanism, a volume selector, a display, and a processor. The tip holder mounts to the body. The piston assembly mounts to the tip holder and includes, but is not limited to, a piston rod that fits within the tip holder. The piston drive mechanism includes, but is not limited to, a control rod having a surface that contacts the piston assembly. The piston drive mechanism is configured to move the piston rod of the piston assembly within the tip holder thereby causing regulation of a liquid in the tip holder. The volume selector mounts to the body and is configured to allow a user to select a requested volume. The requested volume represents the amount of liquid to regulate. The display mounts to the body. The processor couples to the display and to the volume selector and is configured to calculate a correction volume using a volume characterization. The volume characterization characterizes a difference in the amount of the liquid regulated in the tip holder as a function of the requested volume. The volume characterization is determined using a calibration process. The display indicates the correction volume to a user of the pipette thereby regulating the requested volume of liquid in the tip holder.

Other principal features and advantages of the invention will become apparent to those skilled in the art upon review of the following drawings, the detailed description, and the appended claims.

### BRIEF DESCRIPTION OF THE DRAWINGS

The preferred embodiments will hereafter be described with reference to the accompanying drawings, wherein like numerals will denote like elements.

FIG. 1 is a cross sectional view of an electronic pipette in accordance with an exemplary embodiment of the present invention.

FIG. 2 is a cross sectional view of a piston drive mechanism, a piston assembly, a tip holder, and an external tip ejection mechanism of the electronic pipette of FIG. 1.

FIG. 3 is a cross sectional view of a non-motorized pipette in accordance with an exemplary embodiment of the present invention.

FIG. 4 is a cross sectional view of the non-motorized pipette of FIG. 3 attached to a calibration instrument in accordance with a first exemplary embodiment of the present invention.

FIG. 5 is a flow diagram of exemplary calibration operations of the pipette of FIG. 4.

FIG. 6 is a diagram that represents a regulation error between an actual volume and a calibration volume in a pipette.

FIG. 7 is a first exemplary table representing a volume characterization in accordance with an exemplary embodiment of the present invention.

FIG. 8 is a second exemplary table representing a volume characterization in accordance with an exemplary embodiment of the present invention.

FIG. 9 is a diagram that represents a regulation error between an actual volume and a calibration volume in a pipette under different operating conditions.

FIG. 10 is a flow diagram of exemplary operations of the pipette in accordance with an exemplary embodiment of the present invention.

FIG. 11 is a cross sectional view of the piston drive mechanism of the non-motorized pipette of FIG. 3 in accordance with a second exemplary embodiment.

FIG. 12 is a cross sectional view of the piston drive mechanism of the non-motorized pipette of FIG. 3 in accordance with a third exemplary embodiment.

FIG. 13 is a cross sectional view of a tip holder and a surrounding body case of the non-motorized pipette of FIG. 3 in accordance with a fourth exemplary embodiment.

FIG. 14 is a cross sectional view of a sensor in accordance with the fourth exemplary embodiment of FIG. 13.

FIG. 15 is a cross sectional view of the piston drive mechanism and the piston assembly of the non-motorized pipette of FIG. 3 in accordance with a fifth exemplary embodiment.

FIG. 16 is a lateral view of the piston assembly of the non-motorized pipette of FIG. 5 in accordance with the fifth exemplary embodiment.

### DETAILED DESCRIPTION OF THE PREFERRED EMBODIMENTS

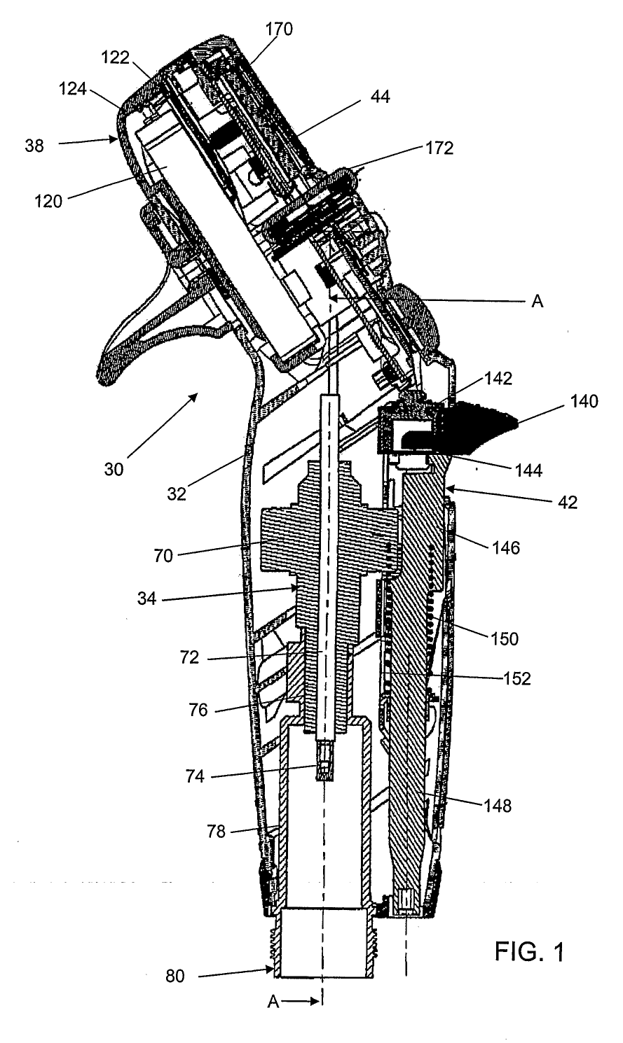

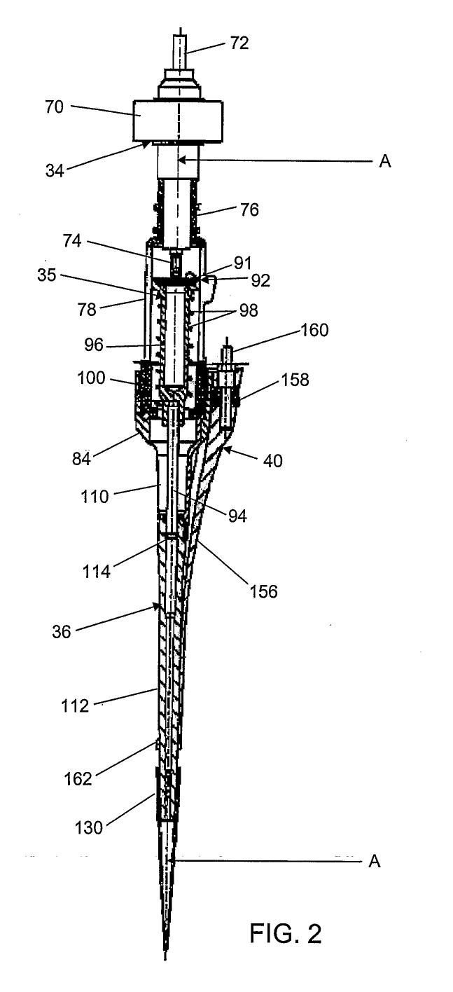

As used in this disclosure, the term “mount” includes join, unite, connect, associate, insert, hang, hold, affix, attach, fasten, bind, paste, secure, bolt, screw, rivet, solder, weld, and other like terms. The term “regulate” includes the aspiration and/or the dispensation of liquid in a pipette. With reference to the exemplary embodiment of FIGS. 1 and 2, an electronic pipette 30 can be commanded to automatically aspirate and dispense a succession of liquid volumes into one or more tip holder 36. The electronic pipette 30 includes a number of components and subsystems that together provide various operational modes for aspirating and dispensing liquids in precise volumes. The components and subsystems of the electronic pipette 30 include, but are not limited to, a body case 32, a piston drive mechanism 34, a piston assembly 35, the tip holder 36, an internal power subsystem 38, an external tip ejection mechanism 40, an internal tip ejection mechanism 42, a control electronics card 44, a display 170, and a volume selector 172. Some of these components and subsystems are known to those skilled in the art, and thus, will not be discussed in significant detail herein. The body case 32 is generally hollow and serves as a positioning reference for the other components of the pipette 30. Most of the pipette components directly or indirectly mount to the body case 32. The body case 32 provides a grip for the user to hold the pipette 30, and is thus, one of the pieces of the pipette that comes into direct contact with the user's hand when the pipette is handled.

The internal power subsystem 38 may comprise a battery 120, a connector 122, and a battery case 124. The battery case 124 holds the battery 120 and fits into the body case 32. The battery may provide power for example, to the piston drive mechanism 34 and/or the control electronics card 44. The connector 122 provides the electrical connection to the control electronics card 44. The control electronics card 44 includes, but is not limited to, a processor, a memory, a clock and other associated electronics (not shown).

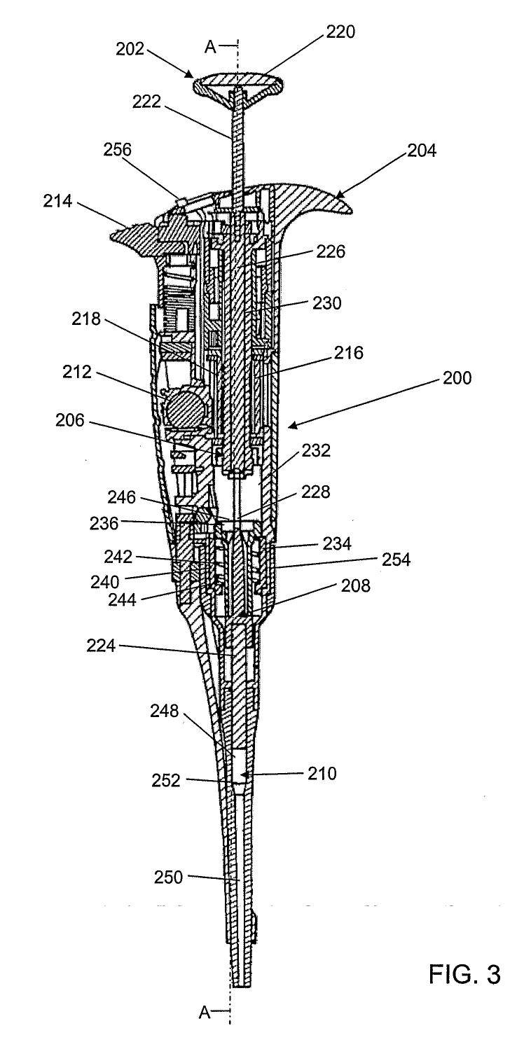

The piston drive mechanism 34 causes the aspiration and dispensation of a specified volume of liquid through the tip holder 36 by moving a piston rod 94 within the piston assembly 35 along the longitudinal axis A-A within the tip holder 36. Motion of the piston produces an air displacement that aspirates or dispense the liquid into or out of the tip holder 36. The piston drive mechanism 34 may be manually controlled by a user, for example, through rotation of a volume selector 202 as shown with reference to FIG. 3 or automatically using a motor 70. With reference to the exemplary embodiment of FIG. 2, the piston drive mechanism 34 may include, but is not limited to, the motor 70, a control rod 72, a control rod tip 74, a control rod support 76, a housing 78, and a tip holder attachment knob 80. The piston drive mechanism 34 may be removably mounted within the body case 32 of the pipette 30 such that the control rod 72 extends along the longitudinal axis A-A.

The motor 70 moves the control rod 72 under the control of the processor mounted to the control electronics card 44. The motor 70 may be implemented using a variety of electromechanical devices as known to those skilled in the art. The motor 70 precisely moves the control rod 72 up and down the longitudinal axis A-A to aspirate or to dispense liquid into or out of the tip holder 36. The motor 70 interfaces with the processor of the control electronics card 44 from which the motor 70 receives electrical signals for controlling the control rod 72 displacement. The control electronics card 44 may include one or more connector or interface for communicating with the motor 70. The control rod tip 74 mounts to an end of the control rod 72 opposite the motor 70. For example, the control rod tip 74 may screw onto or into the control rod 72. The control rod support 76 maintains the control rod 72 displacement along the longitudinal axis A-A. The housing 78 mounts to the control rod support 76 and encloses a portion of the control rod 72 and the control rod tip 74 that extend beyond the control rod support 76 and forms a socket.

With reference to the exemplary embodiment of FIG. 2, the piston assembly 35 includes, but is not limited to, a piston head 92, the piston rod 94, a piston housing 96, a piston return spring 98, and a spring guide 100. The piston head 92 may be a circular disk formed of metallic or plastic material. The piston head 92 has a first face 91. The piston rod 94 mounts to the piston head 92 and extends in a generally perpendicular direction opposite the first face 91 of the piston head 92. The piston rod 94 has a generally cylindrical shape.

The piston housing 96 mounts to the piston head 92, extends in a generally perpendicular direction opposite the first face 91 of the piston head 92, and encloses the piston rod 94. The piston housing 96 has a generally cylindrical shape and may include one or more tapered section. The piston return spring 98 mounts to the piston housing 96 and extends in a generally perpendicular direction opposite the first face 91 of the piston head 92 along the longitudinal axis A-A. In an exemplary embodiment, the piston return spring 98 slides over the piston housing 96 and is held in place by friction forces between the piston return spring 98 and a section of the piston housing 96 adjacent the piston head 92. The piston assembly 35 slides into the housing 78 of the piston drive mechanism as shown with reference to FIG. 2.

As shown with reference to the exemplary embodiment of FIG. 2, the tip holder 36 includes, but is not limited to, an upper tube 110, a lower tube 112, and an O-ring 114. The lower tube 112 mounts to the upper tube 110. For example, the lower tube 112 may include a threaded end that screws into a complementarily threaded surface of the upper tube 110. The upper tube 110 and the lower tube 112 may include one or more tapered section. The O-ring 114 is positioned in an undercut located between the upper tube 110 and the lower tube 112. The O-ring 114 provides a watertight connection between the piston rod 94 and the lower tube 112. A tube attachment nut 84 slides over the tip holder 36 that presses against the piston assembly 35 thereby immobilizing the tip holder 36 relative to the body case 32 and the piston drive mechanism 34.

The control rod tip 74 contacts the first face 91 of the piston assembly 35 within the housing 78 of the piston drive mechanism 34. When dispensing liquid, the piston drive mechanism 34, through displacement of the control rod tip 74 along the longitudinal axis A-A, pushes the piston assembly 35 away from the piston drive mechanism 34 at the point where the control rod tip 74 contacts the first face 91. The piston return spring 98 compresses against the spring guide 100 held in place by the tube attachment nut 84. When aspirating liquid, the piston drive mechanism 34 moves the control rod tip 74 toward the piston drive mechanism 34. Despite this displacement, the first face 91 remains in contact with the control rod tip 74 as a result of the compressive force of the piston return spring 98.

The external tip ejection mechanism 40 and the internal tip ejection mechanism 42 eject the tip 130 from the aspirating and dispensing end of the pipette 30 avoiding possible contamination of samples. The internal tip ejection mechanism 42 includes, but is not limited to, an ejection knob 140, a stationary cylinder 142, a knob cylinder 144, a body cylinder 146, a rod 148, an ejection spring 150, and a mounting brace 152. The stationary cylinder 142 mounts to the body case 32. The mounting brace 152 mounts to the body case 32 and/or the stationary cylinder 142. The stationary cylinder 142 and the mounting brace 152 remain fixed to the body case 32. The ejection knob 140 mounts to the knob cylinder 144. The ejection knob 140 may be rotatable about the longitudinal axis A-A thereby accommodating comfortable operation using either a left or a right hand of a user. The knob cylinder 144 slidably mounts to the stationary cylinder 142 to allow motion of the knob cylinder 144 in combination with depression of the ejection knob 140 to eject the tip 130. The body cylinder 146 mounts to the knob cylinder 144. The rod 148 mounts to an end of the body cylinder 146 opposite the knob cylinder 144. The ejection spring 150 mounts to the body cylinder 146 at a first end 156 and to the mounting brace 152 at a second end 158. Depression of the ejection knob 140 drives the rod 148 toward the tip 130. The ejection spring 150 causes the rod 148 to return in the opposite direction thereby moving the ejection knob 140 back into the original position when the ejection knob 140 is released.

With reference to FIG. 2, the external tip ejection mechanism 40 includes, but is not limited to, an ejection blade 156 and an ejection blade adjustment knob 158. The ejection blade 156 has a curved shape that follows the external shape of the tip holder 36. The ejection blade 156 has a first end 160 and a second end 162. The second end 162 comprises an enclosed cylinder that slides over the tip holder 36. As a result, depression of the ejection knob 140 causes motion of the ejection blade 156 along the tip holder 36 ejecting the tip 130 from the tip holder 36 with the second end 162. Rotation of the ejection adjustment knob 158 mounted to the ejection blade 156 near the first end 160 causes the second end 162 of the ejection blade 156 to move up or down the tip holder 36. Adjustment of the ejection blade 156 location along the tip holder 36 allows the external tip ejection mechanism 40 to eject tips of different types.

The pipette 30 may include a communication interface to communicate with a computing device. The computing device may be a computer of any form factor including a desktop, a laptop, a personal data assistant, etc. The computing device is physically distinct from the pipette 30. The communication interface may be located on a top of the body case 32 opposite the tip 130 for easy accessibility by the user without interrupting the operation of the pipette 30. Communication between the pipette 30 and the computing device may use various transmission technologies including, but not limited to, Code Division Multiple Access (CDMA), Global System for Mobile Communications (GSM), Universal Mobile Telecommunications System (UMTS), Time Division Multiple Access (TDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. The pipette 30 and the computing device may communicate using various media including, but not limited to, radio, infrared, laser, cable connection, etc. Thus, the communication interface may utilize a wired connection and/or a wireless connection.

The wired connection may include a first end that connects with the communication interface of the pipette 30 and a second end that connects with a communication interface of the computing device. In an exemplary embodiment, the communication interface of the pipette 30 meets the Institute of Electrical and Electronics Engineers (IEEE) 1394 mini standards. In an exemplary embodiment, the communication interface of the computing device may be of type RS 232 that is designed to accept a Universal Serial Bus connector. In an alternative embodiment, the communication interface of the pipette 30 and/or the communication interface of the computing device may be an Ethernet interface.

Wireless communication interfaces may connect devices over various distances from short to long. The pipette 30 and the computing device may support processing for broadcasting and receiving a wireless signal. The wireless signal may, for example, use the IEEE 802.11™ standard, using either version 802.11a, 802.11b, 802.11f or 802.11g. Additionally, the wireless signal may, for example, use the BLUETOOTH standard of which IEEE 802.15.1 is the most recent version. The IEEE 802.11™ specifications define wireless standards for Wireless Local Area Networks (WLANs) that provide an “over-the-air” interface between a wireless client and a base station or access point, as well as among other wireless clients. The IEEE 802.15 Working Group provides standards for low-complexity and low-power consumption Wireless Personal Area Networks (PANs) such as those supported by the Bluetooth specification.

With reference to FIG. 3, a cross sectional view of a non-motorized pipette 200 is shown in an exemplary embodiment. The components and subsystems of the non-motorized pipette 200 include, but are not limited to, the volume selector 202, a body case 204, a piston drive mechanism 206, a piston assembly 208, a tip holder 210, a battery 212, a tip ejection mechanism 214, a display 216, a control electronics card 218, and an indicator 256 of a type of tip. Some of these components and subsystems are known to those skilled in the art, and thus, will not be discussed in significant detail herein. The volume selector 202 includes a knob 220 and an adjustment screw 222. Rotating the knob 220 causes the adjustment screw 222 to move up and down in the longitudinal direction A-A thereby changing the requested volume to aspirate or to dispense.

The body case 204 is made of a single piece of material. In an exemplary embodiment, the material is plastic. The body case 204 is generally hollow and serves as a positioning reference for the other components of the pipette 200. For example, the position of the adjustment screw 222 is adjustable with respect to the body case 204 and controls the setting of the requested volume of liquid to regulate. Thus, many of the pipette components directly or indirectly mount to the body case 204. The body case 204 includes, but is not limited to, a window through which the display 216 is visible. The window may be formed of glass or clear plastic. The body case 204 provides a grip for the user to hold the pipette 200, and is thus, one of the pieces of the pipette that comes into direct contact with the user's hand when the pipette is handled.

The piston drive mechanism 206 causes the aspiration and dispensation of a requested volume of liquid through the tip holder 210 by moving a piston rod 224 within the piston assembly 208 along the longitudinal axis A-A. Motion of the piston rod produces an air displacement that aspirates or dispense the liquid into or out of the tip holder 210. The piston drive mechanism 206 may include, but is not limited to, a control rod 226, a control rod tip 228, a control rod support 230, a housing 232, and a tip holder attachment knob 234. The piston drive mechanism 206 may be removably mounted within the body case 204 of the pipette 200 such that the control rod 226 extends along the longitudinal axis A-A. In an exemplary embodiment, the tip holder attachment knob 254 mounts to the tip holder attachment knob 234 fixing the internal parts of the pipette 200.

Rotation of the knob 220 causes translational movement of the control rod 226. The control rod tip 228 mounts to an end of the control rod 226 opposite the knob 220. For example, the control rod tip 228 may screw onto or into the control rod 226. The control rod support 230 maintains the control rod 226 displacement along the longitudinal axis A-A. The housing 232 mounts to the control rod support 230 and encloses the portion of the control rod 226 and the control rod tip 228 that extend beyond the control rod support 230 forming a socket.

The piston assembly 208 includes, but is not limited to, a piston head 236, the piston rod 224, a piston housing 240, a piston return spring 242, and a spring guide 244. The piston head 236 may be a circular disk formed of metallic or plastic material. The piston head 236 has a first face 246. The piston rod 224 mounts to the piston head 236 and extends in a generally perpendicular direction opposite the first face 246 of the piston head 236. The piston rod 224 has a generally cylindrical shape.

The piston housing 240 mounts to the piston head 236, extends in a generally perpendicular direction opposite the first face 246 of the piston head 236, and encloses the piston rod 224. The piston housing 240 has a generally cylindrical shape and may include one or more tapered section. The piston return spring 242 mounts to the piston housing 240 and extends in a generally perpendicular direction opposite the first face 246 of the piston head 236 along the longitudinal axis A-A. In an exemplary embodiment, the piston return spring 242 slides over the piston housing 240 and is held in place by friction forces between the piston return spring 242 and a section of the piston housing 240 adjacent the piston head 236. When assembled, the piston assembly 208 slides into the housing 232 of the piston drive mechanism 206 as shown with reference to FIG. 3.

As shown with reference to the exemplary embodiment of FIG. 2, the tip holder 210 includes, but is not limited to, an upper tube 248, a lower tube 250, and an O-ring 252. The lower tube 250 mounts to the upper tube 248. For example, the lower tube 250 may include a threaded end that screws into a complementarily threaded surface of the upper tube 248. The upper tube 248 and the lower tube 250 may include one or more tapered section. The O-ring 252 is positioned in an undercut located between the upper tube 248 and the lower tube 250. The O-ring 252 provides a watertight connection between the piston rod 224 and the lower tube 250. A tube attachment nut 254 slides over the tip holder 210 that presses against the piston assembly 208 thereby immobilizing the tip holder 210 relative to the body case 204 and the piston drive mechanism 206.

The control rod tip 228 contacts the first face 246 of the piston assembly 208 within the housing 232 of the piston drive mechanism 206. When dispensing liquid, the piston drive mechanism 206, through displacement of the control rod tip 228 along the longitudinal axis A-A, pushes the piston assembly 208 away from the piston drive mechanism 206 at the point where the control rod tip 228 contacts the first face 246. The piston return spring 242 compresses against the spring guide 244 held in place by the tube attachment nut 254. When aspirating liquid, the piston drive mechanism 206 moves the control rod tip 228 toward the piston drive mechanism 206. Despite this displacement, the first face 246 remains in contact with the control rod tip 228 as a result of the compressive force of the piston return spring 242.

The tip ejection mechanism 214 ejects the tip 130 from the aspirating and dispensing end of the pipette 30 avoiding possible contamination of samples in a similar manner as described above with reference to FIGS. 2 and 3. The display 216 presents information to the user of the pipette. For example, the requested volume selected by the user through rotation of the knob 220 may be displayed at the display 216. The control electronics card 218 includes, but is not limited to, a processor, a memory, a clock, and other associated electronics (not shown) to control the display 216 and adjustment of the pipette 200. The battery provides energy to, for example, the display 216 and the control electronics card 218.

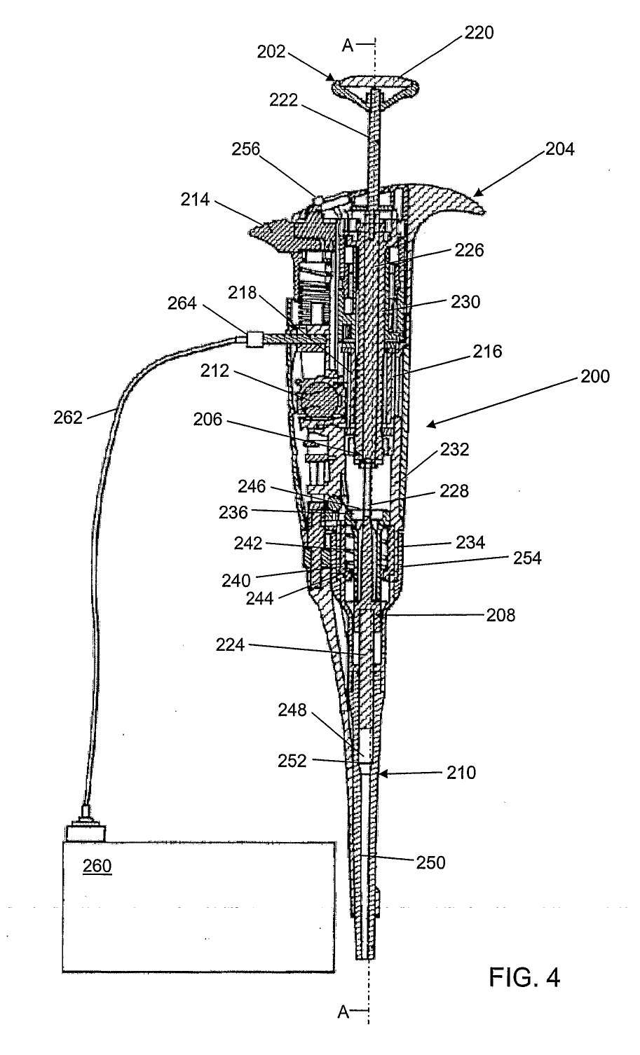

With reference to FIG. 4, the pipette 200, during a calibration process is connected to a scale 260 by a connection wire 262. The connection wire 262 connects to the pipette 200 through a terminal 264 providing direct communication of data from the scale 260 to the memory of the pipette. For example, the terminal 264 may be an RS232-type connector. In an alternative embodiment, the pipette 30 may be used in a similar fashion.

With reference to FIG. 5, a flow diagram of exemplary operations of the calibration process using the pipette 200 of FIG. 4 are shown. In an operation 278, an empty weight of the pipette 200 is determined using the scale 260. In an operation 280, the user selects a calibration volume to regulate at the pipette 200. In an operation 282, the user aspirates the requested volume using the pipette 200. In an operation 284, an aspirated weight of the pipette 200 including the aspirated liquid is measured using the scale 260. In an operation 286, an actual volume aspirated is calculated based on a difference between the aspirated weight of the pipette 200 and the empty weight of the pipette 200 and physical characteristics of the liquid aspirated as known to those skilled in the art. In an operation 288, the calculated actual volume aspirated is sent to the pipette 200 where it is stored in the memory with the calibration volume. For example, the calibration volume and the measured actual volume aspirated may be stored in a database or in a table as known to those skilled in the art. In an operation 290, a test determines if an additional calibration volume should be aspirated. If the determination is yes, the operations 280-288 are repeated for the additional calibration volume. In an alternative embodiment, the empty weight may be calculated for each additional calibration volume. In an operation 292, a volume characterization is determined that characterizes a difference in the amount of liquid regulated as a function of the calibration volume or volumes if additional calibration volumes are used.

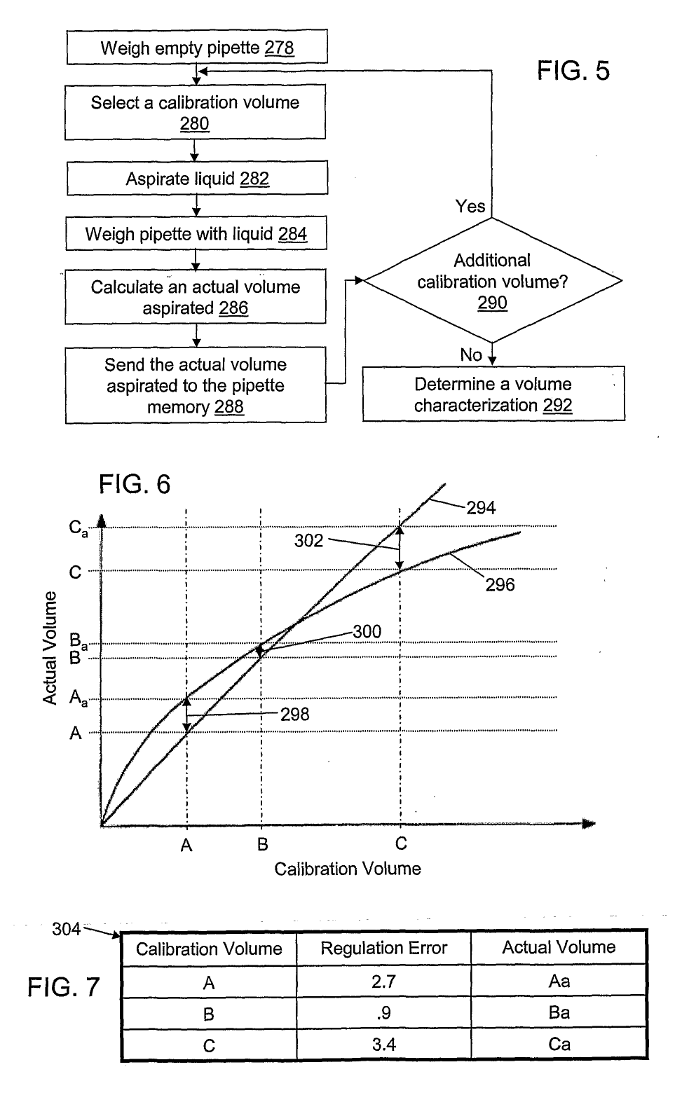

With reference to FIG. 6, an ideal response curve 294 and a measured response curve 296 are shown. The ideal response curve 294 indicates an ideal pipette that aspirates exactly the calibration volume. The measured response curve 296 indicates an actual response of a pipette. The difference between curve 294 and curve 296 represents a regulation error. For example, during the calibration process described with reference to FIG. 5, three calibration volumes, A, B, and C, are selected. Based on the calibration volume A, an actual volume Aₐ is measured during the calibration process. A regulation error 298 is the difference between the calibration volume A and the actual volume Aₐ or Aₐ−A. Similarly, a regulation error 300 is the difference between the calibration volume B and the actual volume Bₐ or Bₐ−B. Again, a regulation error 302 is the difference between the calibration volume C and the actual volume Cₐ or Cₐ−C.

The calibration volume, for example, A, and the corresponding actual volume aspirated Aₐ define a calibration data point. The more calibration data points are used during the calibration process, the more precise an approximation to the measured response curve 296 can be calculated. As known to those skilled in the art of simulation, various methods may be used to approximate the measured response curve 296 using the calibration volume data that includes the calibration volume and the regulation error or the actual volume aspirated. The volume characterization may be determined using any of these methods to determine the measured response curve 296 at volumes other than the calibration volume.

For example, various curve fitting algorithms can be used to provide a best fit to a set of data points. The output of the curve fitting algorithm is an equation. For example, an n^{th} order polynomial may be used to approximate the measured response curve 296 using the calibration data points at A, at B, and at C. Thus, using one or more calibration data point, a volume characterization is determined. For example, the volume characterization may be the equation defined using the curve fitting algorithm. If a single equation is inadequate to simulate the measured response curve 296, additional equations may be defined to define the response to a requested aspiration volume between the calibration volumes. For example, based on the measured response curve 296, a linear equation may be adequate for volumes greater than B. However, a polynomial may better approximate the measured response curve 296 for volumes less than B. In this case, the volume characterization includes two equations.

As an alternative, the volume characterization may be a table that contains a plurality of calibration data points. A determination of an actual volume aspirated is determined by interpolating between calibration data points or extrapolating from a calibration data point using a predetermined equation. As another alternative, the equation to use for interpolation and/or extrapolation from a calibration data point may be included in the table. The data may be captured in the table as known to those skilled in the art. The table may be in any form including, but not limited to, a table defined in a file and a database. With reference to FIG. 7, a table 304 representing a regulation error as a function of the calibration volumes, A, B, and C, is shown for exemplification. Either of or both of the actual volume aspirated and the regulation error can be stored in the table 295.

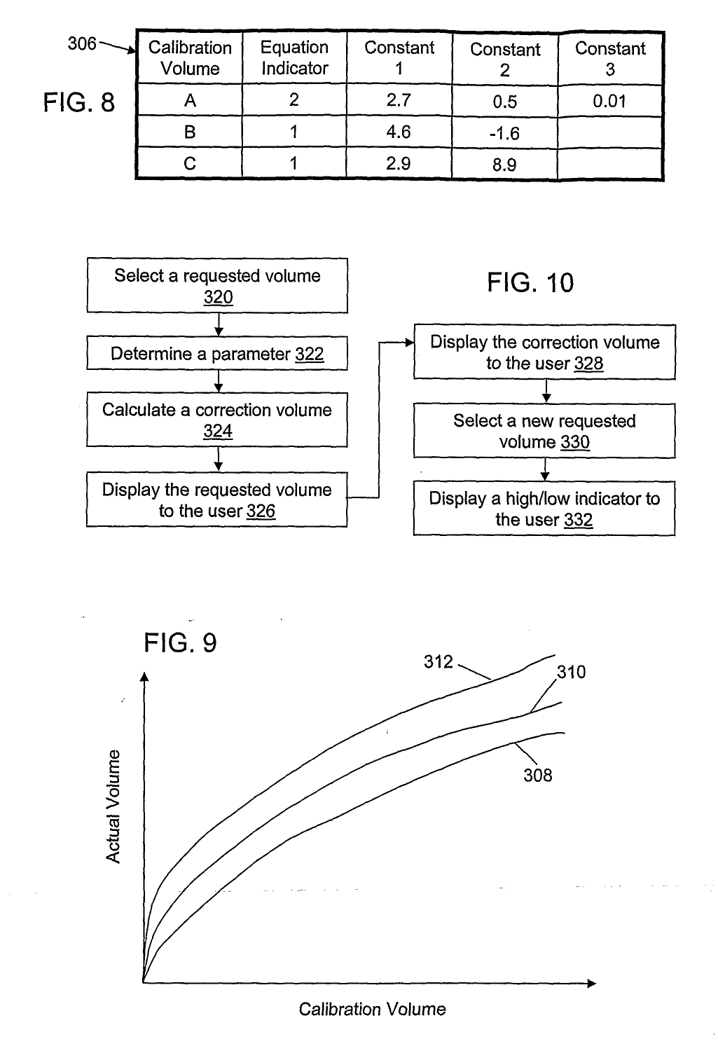

Alternatively, in a table 306 shown with reference to FIG. 8, an equation indicator and associated constants for use with an equation are included. For example, an equation indicator of 1 indicates a linear equation that uses only “Constant 1” to describe the measured response curve 296 between each calibration volume. An equation indicator of 3 indicates a 2^{rd} order polynomial equation that uses “Constant 1”, “Constant 2”, and “Constant 3” to describe the measured response curve 296 between each calibration volume. Thus, the equation 2.7+0.5 A+0.01 A² defines the correction volume for a requested volume less than A. The equation 4.6−1.6 A defines the correction volume for a requested volume greater than A and less than B. The equation 2.9+8.9 A defines the correction volume for a requested volume greater than B.

In an exemplary embodiment, at least two calibration volumes are used to define the volume characterization. Preferably, one of the two calibration volumes is a minimum operating volume of the pipette and the other is a maximum operating volume of the pipette. Calibrating using the pipette's maximum volume allows for a maximum consideration of the mechanical faults, particularly the displacement screw path and the diameter of the piston, and of the weight of the liquid in the tip holder. Calibrating using the pipette's minimum volume allows for a maximum consideration of the mechanical faults and of the capillarity phenomenon. Improved precision may be obtained by using additional calibration volumes. As just related, various interpolation methods, as known to those skilled in the art, may be used to determine a correction volume at a requested volume that is not equal to the one or more calibration volume during operation of the pipette.

One or more equation and/or table may be used to define the volume characterization based on additional physical conditions at the pipette. For example, a first equation and/or table may be defined based on the type of pipette. A second equation and/or table may be defined for the specific pipette because the actual volume measured may differ based on manufacturing tolerances that allow components to vary from pipette to pipette during the manufacturing process.

As an additional example, the measured response curve 296 may change when the pipette is operated in an environment at a different atmospheric temperature. With reference to FIG. 9, three example measured response curves are shown. For example, a measured response curve 308 is defined at an atmospheric temperature of 10 degrees Celsius. A measured response curve 310 is defined at an atmospheric temperature of 20 degrees Celsius. A measured response curve 312 is defined at an atmospheric temperature of 25 degrees Celsius. As a result, a different equation or set of equations or table may be used to define each of the measured response curves 308, 310, and 312. Thus, the volume characterization uses the parameter and the requested volume to determine the correction volume. As known to those skilled in the art, various methods may be used to interpolate between multiple curves. Thus, a parameter representing a current physical condition at the pipette may be used to further define the volume characterization of the pipette thereby correcting for additional sources of variation in the volume aspirated.

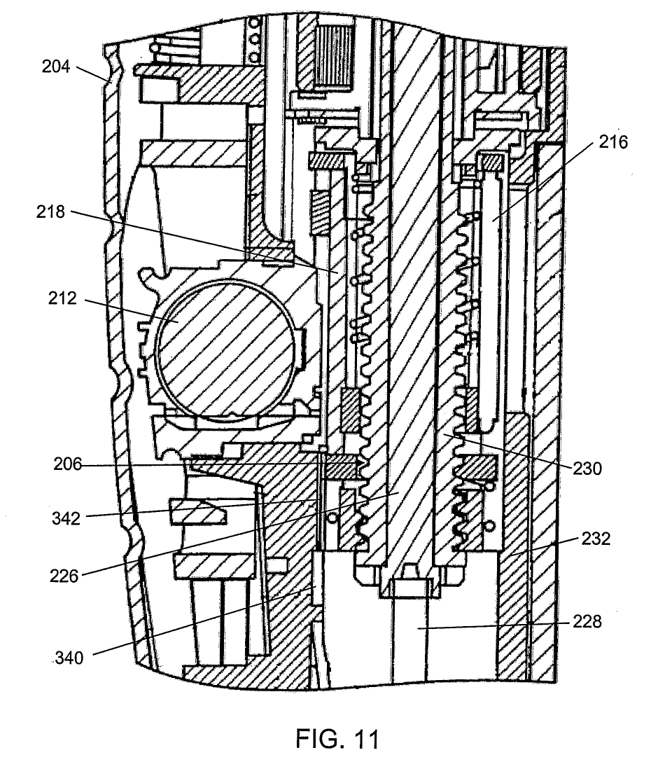

Parameters include, but are not limited to, a type of tip used at the pipette, a temperature of the atmosphere at the pipette, a temperature of a portion of the pipette, a pressure of the atmosphere at the pipette, a pressure within a cavity of the pipette, a humidity of the atmosphere at the pipette, and a viscosity of the liquid to regulate. The indicator 256 of a type of tip may be used by the user of the pipette to select the type of tip placed on the tip holder 210. Tips having a different size and shape may cause a different measured response curve. Thus, the type of tip mounted to the tip holder may change the volume characterization. Additionally, one or more sensor mounted at the pipette (as shown with reference to FIGS. 11-16) may be used to provide the parameter to be used with the volume characterization to calculate a correction volume based on the temperature of the atmosphere at the pipette, the temperature of a portion of the pipette, the pressure of the atmosphere at the pipette, the pressure within a cavity of the pipette, and the humidity of the atmosphere at the pipette. The sensor or indicator additionally may indicate a type of liquid to be regulated. In this case, the volume characterization includes a correction for the selected liquid primarily based on the viscosity of the liquid.

In general, the volume characterization determined using parameters measured by sensors is a regulation error “C” that is a predetermined mathematical equation executed by the processor and accepting the measured parameter for the atmospheric pressure, for the atmospheric temperature, and for the atmospheric humidity. In an exemplary embodiment, “C” can be calculated as: C=a*B+m where “B” is the requested volume, and “a” and “m” are predetermined correction values. The value of “m” may be zero. The parameter “a” may be defined by

a=(1−Dₐₜₘ/e)/(Dᵢ−Dₐₜₘ)

Dᵢ and Dₐₜₘ are the density values of the regulated liquid and of air respectively and “e” is a constant.

The density Dᵢ is calculated by a predetermined mathematical equation having a temperature measured by an atmospheric temperature sensor. In this example, Dᵢ=g/f(Tᵢ) where “g” is a constant, “Tᵢ” is the measured temperature, and “f(Tᵢ)” is a predetermined polynomial function. For example,

Dᵢ=1000/(999.87−0.06426 Tᵢ+0.0085045 Tᵢ²−0.0000679 Tᵢ³)

In this equation, Tᵢ is in degrees Celsius and Dᵢ is in kilograms per metric cube.

In a similar fashion, Dₐₜₘ is calculated by a predetermined mathematical equation having a variable atmospheric pressure, atmospheric temperature, and atmospheric humidity that are measured by the sensors. In this example,

Dₐₜₘ=45 Pₐₜₘ/(12908(Tᵢ+273.15))+(Tᵢ−0.02 H)1000

Pₐₜₘ is the pressure in Pascal and H is the percentage of humidity. For example, H is 0.4 for a 40% humidity.

With reference to FIG. 10, exemplary operations of a procedure to correct regulation of a liquid at the pipette during use based on the volume characterization determined during the calibration process are shown. In an operation 320, the user selects a requested volume to regulate using the pipette. In an operation 322, a parameter representing a current physical condition at the pipette is determined. Using a volume characterization stored in the memory of the pipette, a correction volume is calculated in an operation 324 using the processor. The volume characterization determines the difference in the amount of liquid regulated as a function of the requested volume and/or the parameter. Thus, the correction volume represents the difference in the amount of liquid regulated as a function of the requested volume and/or the parameter. In an operation 326, the requested volume may be displayed to the user.

In an operation 328, the correction volume is displayed to the user. The correction volume may be the actual volume aspirated or may be the regulation error at the requested volume based on, for example, interpolation of an equation between two calibration data points that bound the requested volume. In an operation 330, the user may select a new requested volume based on the displayed correction volume. For example, if the pipette is not motorized, the display may indicate the correction volume and the requested volume. In response the user selects a new requested volume until the correction volume matches the requested volume within the precision required by the user.

In an alternative embodiment, the correction volume is displayed as the requested volume so that the process of correcting the pipette based on the requested volume and the parameter is transparent to the user. Thus, for example, using the motorized pipette 20, the processor may automatically correct the control rod location to include the regulation error. The display displays the requested volume which is also the correction volume because the processor adjusts the position of the control rod to regulate the requested volume while including the effects of the physical condition of the pipette 20 and of the volume requested. Thus, in the mode of operation characterized by an automatic correction of the display, the display of the requested volume automatically incorporates the correction. The display changes with the physical conditions at the pipette, and the user does not need to make any adjustments.

A high/low indicator may be displayed to the user of the pipette at an operation 332. The high/low indicator indicates whether the regulation error is positive or negative. The high/low indicator may be a minus sign if there is a risk of underdosage as when the actual volume is higher than the calibration volume or a plus sign if there is a risk of overdosage as when the actual volume is lower than the calibration volume. In summary, three pieces of information may be provided to the user on the display at the pipette: the requested volume, the correction volume, and the high/low indicator. The correction volume may be a regulation error or may be an actual volume. Using this information, the user can adjust the requested volume until the high/low indicator shows neither positive nor negative indicating equivalence between the requested volume and the correction volume within a precision error. In an alternative embodiment, the high/low indicator is not displayed at the pipette.

In another alternative embodiment, use of the procedure to correct the volume regulated is an option selectable by the user. Thus, the user may choose to command the processor not to include any correction values as the user regulates liquid using the pipette. In another alternative embodiment, the processor at the pipette may be programmed to perform the correction only when the correction is greater than, for example, a precision value. Predetermined precision values can be chosen to discriminate between circumstances that involve significant correction and those that do not. Such embodiments, maximize the user control over the operation of the pipette.

The calibration process shown with reference to FIG. 5 and the usage procedure shown with reference to FIG. 10, correct the amount of liquid regulated at the pipette due to the capillarity phenomena resulting from a low requested volume, due to the weight of the liquid column from a large requested volume, due to imperfect manufacture of components of the pipette, due to the type of tip, and due to physical conditions at the pipette that include the temperature of the atmosphere at the pipette, the temperature of a portion of the pipette, the pressure of the atmosphere at the pipette, the pressure within a cavity of the pipette, the humidity of the atmosphere at the pipette, and the viscosity of the liquid regulated. For example, when a user handles the pipette over an extended period, the pipette heats up from the contact with the user's hand so that the operation of the pipette changes due to the thermal expansion of some components. Based on the outlined procedure, the precision of the pipette can be maintained as the pipette heats up and in fact maintains the precision of the pipette over a large range of pipette operating conditions. The pipette may adjust automatically. Alternatively, the displayed correction volume may indicate to the user the change and the user may manually adjust the pipette. Because the pipette is corrected after manufacture, the required precision in manufacture of the pipette can be relaxed. As a result, pipettes can be more easily manufactured with less expense. The various expansions of the mechanical system that usually cause a drift of the sampling displacement volume directly affecting the quantity sampled are also mitigated. Successive corrections may be included to consider the multiple physical conditions.

With reference to FIGS. 11-16, exemplary sensor configurations are shown that provide the parameters for use as inputs to the volume characterization. With reference to FIG. 8, a second exemplary embodiment of the pipette 200 is shown. The pipette additionally includes a temperature sensor 340 mounted adjacent the housing 232 of the piston drive mechanism 206. The temperature sensor 340 is positioned to measure the temperature of a portion of the pipette 200. In the exemplary embodiment, the temperature sensor 340 is located close to the control rod 226, the control rod support 230, and the control electronics card 218. The control electronics card 218 is likely to generate heat that may cause expansion of some components of the piston drive mechanism 206. The temperature sensor 340 is mounted close to the parts most subject to thermal expansion, thus, allowing the temperature of the mechanical components involved in the sampling sequence to be known. The temperature sensor 340 is connected via electrical connection wires 342 to the control electronics card 218 in order for the processor to adjust for the temperature measured by the sensor.

This adjustment may be performed according to the procedure shown with reference to FIG. 11 using the temperature measured by the sensor as the parameter. During calibration, pipettes typically are operated for aspirating/dispensing liquid at approximately 20 degrees Celsius. If the user regulates a liquid that is not at 20 degrees Celsius, the volume regulated will not correspond to the value indicated on the display of the pipette. The removed volume may be different than the requested volume for various reasons. The main reason for this error is the warming of the “dead” volume in the interior of the pipette that, due to its expanding, causes the user to regulate less liquid than would be regulated with a predicted regulation/adjustment. Knowing that the pipette calibration specifications, especially those for setting the nominal sample volume, are given for a pipette at 20 degrees Celsius, the processor determines whether a correction of this nominal value is necessary depending on the temperature determined by the temperature sensor 340 and the volume characterization based on the temperature.

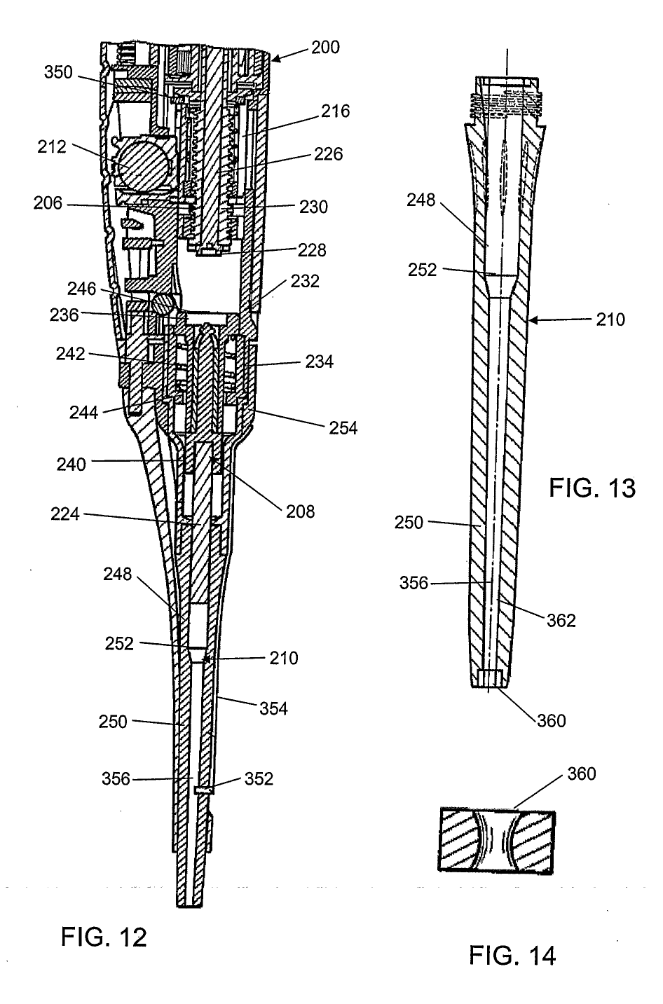

With reference to FIG. 12, a third exemplary embodiment of the pipette 200 is shown. The pipette additionally includes a an atmospheric pressure sensor 350 mounted adjacent the piston drive mechanism 206. In this example, the sensor is mounted above the battery 212. The atmospheric pressure sensor 350 measures the atmospheric pressure and sends the information to the processor to correct the regulated volume as related previously. The pipette may additionally include an atmospheric temperature sensor 352 mounted to an exterior of the tip holder near the tip. At this location, the atmospheric temperature sensor 352 measures the temperature close to the regulated liquid permitting a close approximation of the temperature of the liquid even though the sensor is only in contact with the air above the liquid. The atmospheric temperature sensor 352 penetrates the surface of the tip holder through to an internal tube 356 to measure the atmospheric temperature close to the regulated liquid. The atmospheric temperature sensor 352 is connected via electrical connection wires 354 to the control electronics card 218 in order for the processor to adjust for the temperature measured by the sensor. In another alternative embodiment, a humidity sensor may be mounted to the pipette in a similar location as described with respect to the atmospheric pressure sensor 350.

With reference to FIG. 13, a fourth exemplary embodiment of the pipette is shown. The pipette additionally includes an atmospheric temperature sensor 360 mounted to the lower tube of the tip holder 210. The atmospheric temperature sensor 360 forms a ring at the lower tube of the tip holder that permits it to be received in a cylinder casing arranged at the lower extremity of the tip holder. The atmospheric temperature sensor 360 has an internal wall identical to a torus thus forming a curve arranged in a circle with its center situated on the wall opposite the longitudinal axis A-A of the pipette as shown with reference to FIG. 14. The restricted air passage formed permits an increased air speed across the atmospheric temperature sensor 360 as well as a removal of liquid through an ejection. The atmospheric temperature sensor 360 is connected via electrical connection wires 362 to the control electronics card 218 in order for the processor to adjust for the temperature measured by the sensor.

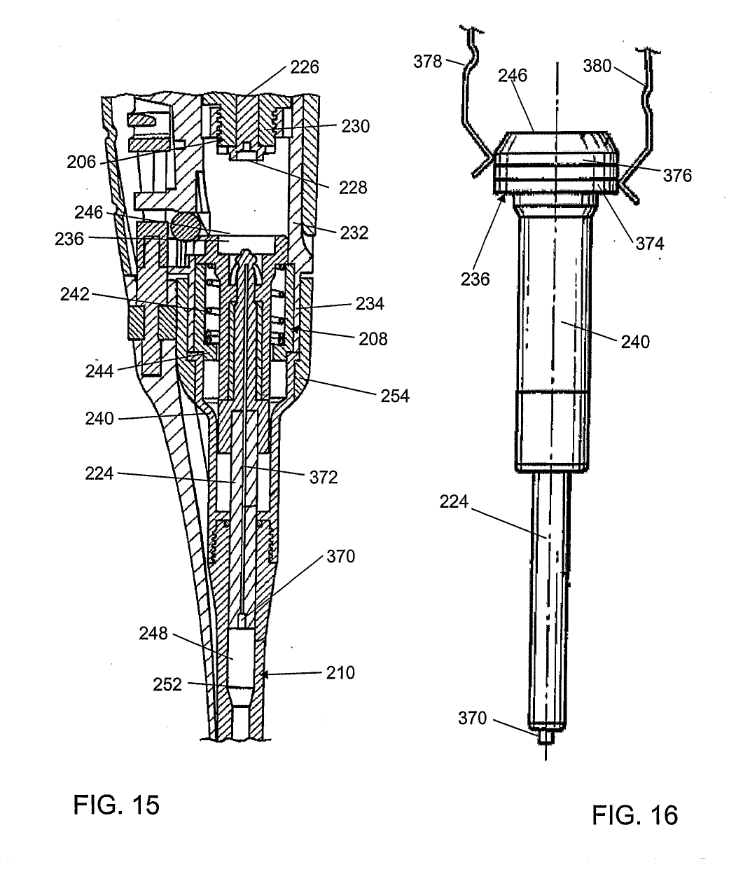

With reference to FIG. 15, a fifth exemplary embodiment of the pipette is shown. The pipette additionally includes an atmospheric temperature sensor 370 mounted to a mobile part within the pipette. The atmospheric temperature sensor 370 is fixed directly to an end of the piston rod 224. At this location, the atmospheric temperature sensor 370 does not contact the regulated liquid. The atmospheric temperature sensor 370 is connected via electrical connection wires 372 to the control electronics card 218 in order for the processor to adjust for the temperature measured by the sensor. With reference to FIG. 16, the electrical connection wire 372 is connected to two metallic bands 374, 376 layered one above the other perpendicular to the pipette's longitudinal axis A-A, and at the piston head. The metallic bands 374, 376 are respectively in contact with two blades 378, 380 mounted to the pipette body case. This arrangement permits a permanent, electric contact between the processor and the atmospheric temperature sensor 370 despite the rotation of the piston rod.

Exemplary embodiments of the present invention, effectively train the pipette to precisely aspirate or dispense volumes of liquid under a variety of environmental operating conditions, using a variety of viscous liquids and types of tips, over a range of volumes despite mechanical faults in the manufacture of the pipette. The exemplary operations may be applied using either a non-motorized or a motorized pipette. It is understood that the invention is not confined to the particular embodiments set forth herein as illustrative, but embraces all such modifications, combinations, and permutations as come within the scope of the following claims. The functionality described may be distributed among components that differ in number and distribution of functionality from those described herein without deviating from the spirit of the invention. Additionally, the order of execution of the modules may be changed without deviating from the spirit of the invention. Thus, the description of the preferred embodiments is for purposes of illustration and not limitation.

What is claimed is:

1. A method of regulating a requested volume of liquid in a liquid handling pipette by correcting for a current physical condition at the pipette, the method comprising:
selecting a requested volume at a pipette, the pipette including a piston drive mechanism, the piston drive mechanism configured to contact a piston assembly to move a piston rod of the piston assembly within a tip holder thereby causing regulation of an amount of liquid in the tip holder, the requested volume representing the amount of liquid to regulate;
calculating a correction volume using a volume characterization, wherein the volume characterization characterizes a difference in the amount of the liquid regulated in the tip holder as a function of the requested volume, the volume characterization determined using a calibration process; and
displaying the correction volume to a user of the pipette thereby regulating the requested volume of liquid in the tip holder.

2. The method of claim 1, further comprising:
determining a parameter, the parameter representing a current physical condition at the pipette;
wherein the volume characterization further characterizes a difference in the amount of the liquid regulated in the tip holder as a function of the parameter.

3. The method of claim 2, wherein the parameter is a type of tip.

4. The method of claim 2, wherein the parameter is measured by a sensor mounted at the pipette.

5. The method of claim 4, wherein the parameter is selected from the group consisting of a temperature of the atmosphere at the pipette, a temperature of a portion of the pipette, a pressure of the atmosphere at the pipette, a pressure within a cavity of the pipette, a humidity of the atmosphere at the pipette, and a viscosity of the liquid.

6. The method of claim 2, further comprising displaying the requested volume to the user of the pipette.

7. The method of claim 1, wherein the correction volume is an actual volume, the actual volume representing the amount of liquid regulated in the tip holder based on the requested volume.

8. The method of claim 1, wherein the correction volume is a regulation error, the regulation error representing a difference between the requested volume and an actual volume, the actual volume representing the amount of liquid regulated in the tip holder based on the requested volume.

9. The method of claim 8, further comprising the user selecting a new volume at the pipette, wherein the new volume includes the regulation error.

10. The method of claim 8, further comprising displaying a high/low indicator to a user of the pipette, the high/low indicator indicating whether the regulation error is positive or negative.

11. The method of claim 1, wherein the volume characterization is a table, the table comprising:
a plurality of data points, wherein each data point includes
a calibration volume data point, wherein the calibration volume data point represents a volume of the liquid to regulate, the calibration volume data point selected as part of a calibration process at the pipette; and
the correction volume, wherein the correction volume represents the amount of liquid regulated in the tip holder at the calibration volume data point.

12. The method of claim 1, wherein the volume characterization is a table, the table comprising:
a plurality of data points, wherein each data point includes
a calibration volume data point, wherein the calibration volume data point represents a volume of the liquid to regulate, the calibration volume data point selected as part of a calibration process at the pipette; and
the correction volume, wherein the correction volume represents the difference between the calibration volume data point and an actual volume, wherein the actual volume represents the amount of liquid regulated in the tip holder at the calibration volume data point.

13. The method of claim 1, wherein the volume characterization is an equation.

14. A device for regulating a requested volume of liquid in a liquid handling pipette by correcting for a current physical condition of the pipette, the device comprising:
a body case;
a tip holder, the tip holder mounted to the body case;
a piston assembly, the piston assembly mounted to the tip holder and comprising a piston rod that fits within the tip holder;
a piston drive mechanism, the piston drive mechanism comprising a control rod having a surface that contacts the piston assembly, the piston drive mechanism configured to move the piston rod of the piston assembly within the tip holder thereby causing regulation of a liquid in the tip holder;
a volume selector, the volume selector mounted to the body case and configured to allow a user to select a requested volume, the requested volume representing the amount of liquid to regulate;
a display, the display mounted to the body case;
a processor, the processor coupled to the display and to the volume selector and configured to calculate a correction volume using a volume characterization, wherein the volume characterization characterizes a difference in the amount of the liquid regulated in the tip holder as a function of the requested volume, the volume characterization determined using a calibration process;
wherein the display indicates the correction volume to a user of the pipette thereby regulating the requested volume of liquid in the tip holder.

15. The device of claim 14, further comprising
a physical condition indicator, the physical condition indicator mounted to a portion of the device and configured to indicate a current physical condition at the device;
wherein the processor is coupled to the physical condition indicator and further wherein the volume characterization further characterizes the difference in the amount of the liquid regulated in the tip holder as a function of the indicated current physical condition.

16. The device of claim 15, further comprising:
a tip, the tip mounted to the body case;
wherein the physical condition indicator is an indicator of a type of the tip.

17. The device of claim 15, wherein the physical condition indicator is a sensor.

18. The device of claim 17, wherein the current physical condition is selected from the group consisting of a temperature of the atmosphere at the pipette, a temperature of a portion of the pipette, a pressure of the atmosphere at the pipette, a pressure within a cavity of the pipette, a humidity of the atmosphere at the pipette, and a viscosity of the liquid.

19. The device of claim 14, wherein the display is further configured to indicate the requested volume to the user of the pipette.

20. The device of claim 14, wherein the correction volume is an actual volume, the actual volume representing the amount of liquid regulated in the tip holder based on the requested volume.

21. The device of claim 14, wherein the correction volume is a regulation error, the regulation error representing a difference between the requested volume and an actual volume, the actual volume representing the amount of liquid regulated in the tip holder based on the requested volume.

22. The device of claim 21, wherein the volume selector is further configured to allow the user to select a new volume, wherein the new volume includes the regulation error.

23. The device of claim 21, wherein the display is further configured to display a high/low indicator to the user of the pipette, the high/low indicator indicating whether the regulation error is positive or negative.

24. The device of claim 14, wherein the volume characterization is a table, the table comprising:
a plurality of data points, wherein each data point includes
a calibration volume data point, wherein the calibration volume data point represents a volume of the liquid to regulate, the calibration volume data point selected as part of a calibration process at the pipette; and
the correction volume, wherein the correction volume represents the amount of liquid regulated in the tip holder at the calibration volume data point.

25. The device of claim 14, wherein the volume characterization is a table, the table comprising:
a plurality of data points, wherein each data point includes
a calibration volume data point, wherein the calibration volume data point represents a volume of the liquid to regulate, the calibration volume data point selected as part of a calibration process at the pipette; and
the correction volume, wherein the correction volume represents the difference between the calibration volume data point and an actual volume, wherein the actual volume represents the amount of liquid regulated in the tip holder at the calibration volume data point.

26. The device of claim 14, wherein the volume characterization is an equation.
